(19) United States
(12) Patent Application Publication
(10) Pub. No.: US 2015/0066603 A1
(43) Pub. Date: Mar. 5, 2015

(54) METHOD AND APPARATUS TO ANALYSE SKILL OF CONTACT CENTER EMPLOYEES FROM THE BEHAVIOR DISPLAYED DURING INTERACTIONS WITH CUSTOMERS USING COMPUTER SOFTWARE

(71) Applicant: Atul Chopra, New Delhi (IN)

(72) Inventor: Atul Chopra, New Delhi (IN)

(73) Assignee: ENHANCESYS INNOVATIONS LLC, Lewes, DE (US)

(21) Appl. No.: 14/017,334

(22) Filed: Sep. 4, 2013

(51) Int. Cl. G06Q 10/06

(52) U.S. Cl. CPC G06Q 10/06393
USPC 705/7.39; 705/7.38

(57) ABSTRACT

A method including the steps of storing a first set of data related to an interaction between a customer and a contact center employee in a computer memory; storing a second set of data regarding an outcome of the interaction in the computer memory; using a computer processor to analyze the first set of data related to the interaction; and using a computer processor to link the second set of data regarding the outcome to the first set of data in the computer memory. The method may further include using a computer processor to determine a score for the contact center employee based on the outcome of the interaction. The method may further include displaying the score for the contact center employee on a computer display. An apparatus comprising the computer processor, the computer memory, and/or the computer display may be used to implement one or more methods above.

### FIELD OF THE INVENTION

This invention relates to improved methods and apparatus relating to computer software.

### BACKGROUND OF THE INVENTION

Contact centers are the backbone of customer service. Irrespective of which industry a company operates in, it has to have a contact center where customers, prospects, partners or affiliates can get in touch with, to address queries, or to request for services. The employees working at the contact centers are the face of the organization, and hence, it is imperative that they possess the right skill sets and temperament to manage customer's needs and demands. Today, a contact center representative can be assessed for his or her command over a language and knowledge of the product or service he is associated with, however, there is no way to assess his or her efficiency while dealing with customers.

### SUMMARY OF THE INVENTION

One or more embodiments of the present invention provide a method and apparatus for analyzing the efficiency of a contact center employee by analyzing his or her call recordings, in case of a voice calls based contact center interaction

In at least one embodiment, an apparatus and a method is provided which captures various aspects of a call, such as; rate of words spoken, variation in tone and final outcome of the interaction.

One or more embodiments of the present invention provide a method and apparatus for analyzing the efficiency of a contact center employee by analyzing the mails written by the employee to customers, in case of a structured text based interaction.

In at least one embodiment, an apparatus and a method is provided which captures various aspects of a structured text based communication, such as; number of words typed, grammatical errors, spelling mistakes and final outcome of the interaction.

One or more embodiments of the present invention provide a method and apparatus for analyzing the efficiency of a contact center by analyzing the posts and updates written by the customers on social networks, in case of a unstructured text based interaction.

In at least one embodiment, an apparatus and a method is provided which captures various aspects of an unstructured text based communication, such as; tone of language, nature of words used and final outcome of the interaction.

One or more embodiments of the present invention provide a method and apparatus for analyzing the efficiency of a contact center employee by analyzing the interaction between customers and employees using peer to peer videos.

In at least one embodiment, an apparatus and a method is provided which captures various aspects of a peer to peer video based communication, such as; facial expressions, tone of voice, choice of words and final outcome of the interaction.

One or more embodiments of the present invention provide a method and apparatus for analyzing the efficiency of a contact center by analyzing the help videos published by telecom operators.

In at least one embodiment, an apparatus and a method is provided which captures various aspects of a video based communication using help videos, such as; length of the videos, ranking by customers on helpfulness and final outcome of the interaction.

In at least one embodiment, an apparatus and a method is provided which maps the captured aspects of an interaction with the final outcome of the interaction.

In at least one embodiment, an apparatus and a method is provided which calculates a score based on the mapping of the parameters of the interaction with the final outcome.

At least one embodiment of the present invention provides a method including the steps of storing a first set of data related to an interaction between a customer and a contact center employee in a computer memory; storing a second set of data regarding an outcome of the interaction in the computer memory; using a computer processor to analyze the first set of data related to the interaction; and using a computer processor to link the second set of data regarding the outcome to the first set of data in the computer memory. The method may further include using a computer processor to determine a score for the contact center employee based on the outcome of the interaction. The method may further include displaying the score for the contact center employee on a computer display.

At least one embodiment of the present invention provides an apparatus comprising a computer processor, and a computer memory; wherein the computer processor is programmed by computer software stored in the computer memory to: (a) store a first set of data related to an interaction between a customer and a contact center employee in the computer memory; (b) store a second set of data regarding an outcome of the interaction in the computer memory; (c) analyze the first set of data related to the interaction; and (d) to link the second set of data regarding the outcome to the first set of data in the computer memory. The computer processor may be further programmed by computer software stored in the computer memory to determine a score for the contact center employee based on the outcome of the interaction. The apparatus may further include a computer display; and the computer processor may be further programmed by computer software stored in the computer memory to display the score for the contact center employee on a computer display.

### BRIEF DESCRIPTION OF THE DRAWINGS

FIG. 1 is a block diagram of a user computer and a server computer linked together by the internet for use with an embodiment of the present invention;

FIG. 2 shows a flow chart of a method in accordance with an embodiment of the present invention; and

FIG. 3 shows a block diagram of a method, system, and/or apparatus in accordance with an embodiment of the present invention.

### DETAILED DESCRIPTION OF THE DRAWINGS

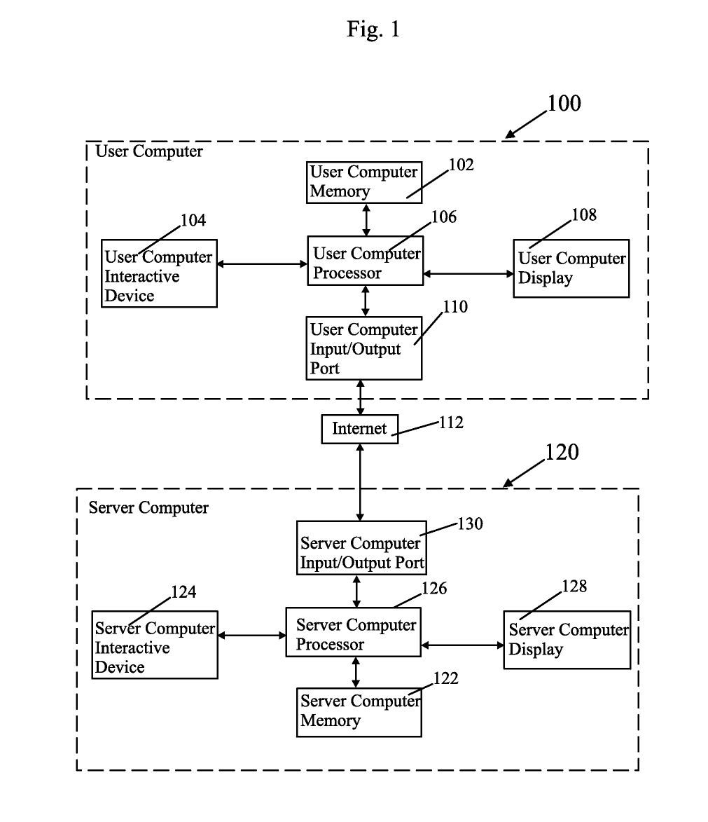

FIG. 1 shows a block diagram of a user computer 100 and a server computer 120, in communication via the internet 112, for use in accordance with one or more embodiments of the present invention. The user computer 100 includes a user computer memory 102, a user computer interactive device 104, a user computer processor 106, a user computer display 108, and a user computer input/output port 110. The user computer interactive device 104 may be a computer touch screen, a computer keyboard, and/or a computer mouse, and/or any other type of computer interactive device.

The server computer 120 includes a server computer memory 122, a server computer interactive device 124, a server computer processor 126, a server computer display 128, and a server computer input/output port 130. The server computer interactive device 124 may be a computer touch screen, a computer keyboard, and/or a computer mouse, and/or any other type of computer interactive device.

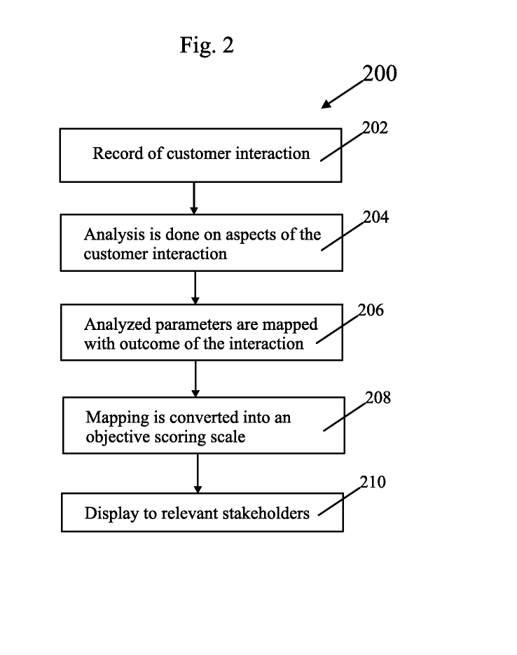

FIG. 2 shows a flow chart 200 of a method in accordance with an embodiment of the present invention. At step 202 a contact center employee or user of user computer 100, using user computer interactive device 104 may record a customer interaction with the contact center employee at step 202, such as by causing data from a customer interaction with the contact center employee to be stored in user computer memory 102 and/or server computer memory 122. The interaction between the customer and the contact center employee may be via telephone and/or internet. Data from a customer interaction with a contact center employee or a plurality of such interactions, including interactions between different customers and different contact center employees, may include audio files of telephone or internet calls or video recordings on the interactions or textual records of emails exchanged. All of this data may be stored in user computer memory 102 and/or server computer memory 122 by the user computer processor 106 and/or the server computer processor 126 as programmed by a computer program stored in computer memory 102 and/or server computer memory 122.

At step 204, the user computer processor 106 and/or the server computer processor 126, as programmed by a computer program stored on user computer memory 102 and/or server computer memory 122, analyzes data and/or aspects from the interaction between a customer and a contact center employee and/or between a plurality of interactions between a plurality of different customers and/or different contact center employees. In at least one embodiment of the present invention, analysis may be done by capturing behavioral patterns of various parameters of each type of interaction. For example: (a) For voice calls: Patterns may be derived or determined by the user computer processor 106 and/or the server computer processor 126 as programmed by a computer program or programs stored in computer memory 102 and/or computer memory 122, based on parameters such as a contact center employee's or a customer's voice modulation, tone of speech, and rate of speech. (b) For text based interactions: Patterns, in at least one embodiment, may be derived or determined by the user computer processor 106 and/or the server computer processor 126 as programmed by a computer program or programs stored in computer memory 102 and/or 122 based on parameters such as average length of sentences, spelling mistakes and grammatical errors for a contact center employee and/or for a customer. (c) For video based interactions: Patterns, in at least one embodiment, may be derived or determined by the user computer processor 106 and/or the server computer processor 126 as programmed by a computer program or programs stored in computer memory 102 and/or 122 based on parameters like facial expressions, tone of voice, rate of speech and voice modulation of a contact center employee and/or for a customer.

At step 206, the user computer processor 106 and/or the server computer processor 126, as programmed by a computer program or programs stored on user computer memory 102 and/or server computer memory 122, map analyzed parameters with an outcome of the interaction. In one or more embodiments of the present invention, I.e. the user computer processor 106 and/or the server computer processor 126 may be programmed by a computer program or programs stored in computer memories 102 and/or 122 to determine one or more outcomes, based on parameters analyzed from the call or calls and may store these outcomes or data representing or referring to these outcomes in computer memory 102 and/or computer memory 122. some examples of outcomes of the call are: (1) customer's query was successfully resolved (desirable or positive outcome); (2) customer's request was successfully logged (desirable or positive outcome); (3) customer's query was not successfully resolved and a subsequent interaction is required (undesirable or negative outcome) (4) (5) customer's request was not successfully logged and a subsequent interaction is required (undesirable or negative outcome); (6) customer provided a satisfactory feedback about the interaction (desirable or positive outcome); (7) customer provided an unsatisfactory feedback about the interaction (undesirable or negative outcome); and (8) Behavioral patterns identified from the previous stage will be associated to the outcome of the interaction, which is what is meant by mapping.

At step 208, in at least one embodiment of the present invention, the user computer processor 106 and/or the server computer processor 126, as programmed by a computer program stored in user computer memory 102 and/or server computer memory 122, converts mapping into an objective scoring scale. For example, after deriving the various patterns as described in step 204, and mapping it with outcomes, or determining outcomes based on analysis of patterns or parameters, as described in step 206, a matrix may be created in the server computer memory 122. This matrix will define the patterns which are most likely to result in a desirable outcome (i.e. a positive outcome such as for example “customer's query was successfully resolved”) and what parameters are least likely to result in a desirable outcome. Based on this matrix, the parameters captured for each agent will be compared and agents who exhibited patterns that resulted in desirable outcomes will be scored higher (e.g. “4” or “5” from a scale or possible scores of “1” to “5” with “1” being the worst and “5” being the best) and agents who exhibited patterns that resulted in undesired outcome or outcomes will be scored lower (e.g. “1”, “2” or “3”)

At step 210, the user computer processor 106 and/or the server computer processor 126, as programmed by a computer program stored in user computer memory 102 and/or server computer memory 122, displays on the user computer display 108 and/or the server computer display 128 and/or other computer displays of people, such as supervisors or stakeholders, who may be evaluating a customer center employee's performance. Supervisors and/or stakeholders, in this example, are people who are evaluating the performance of one or more contact center employees or call center agents. The supervisors and/or stakeholders could be trainers, managers, head of departments in a company, entity, or organization, or anybody who wishes to evaluate the efficiency of a contact center employee or call center agent. Scores may be displayed on user computer display 108, server computer display 128 and/or other computer displays of supervisors and/or stake holders. For example, this display 108, 128, and/or other displays may display Agent One: Score: 5; Agent Two: Score 3, Agent Three: Score 4, and scores for any further number of agents or contact center employees.

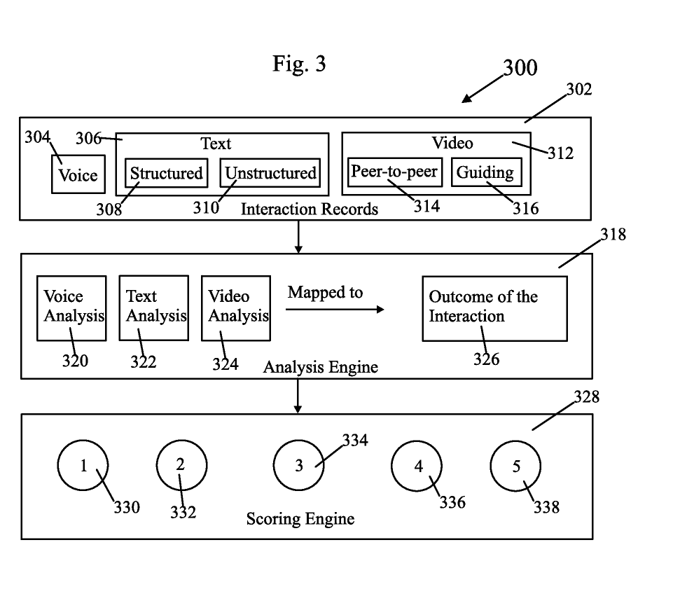

FIG. 3 shows a block diagram 300 of a method, system, and/or apparatus in accordance with an embodiment of the present invention. The diagram 300 shows a block 302 for interaction records, a block 318 for analysis engine, and a block 328 for scoring engine. The interaction records of block 302 may be stored in user computer memory 102 and/or server computer memory 122 by the user computer processor 106 and/or the server computer processor 126, as programmed by a computer program stored in user computer memory 102 and/or server computer memory 122, and/or in response to the user computer interactive device 104 and/or the server computer interactive device 124.

The interaction records 302 may include interaction data concerning a plurality of interactions between different contact center employees and customers. This interaction data may include voice data 304, text data 306, and video data 312. The text data 306 may include structured data 308, which in at least one embodiment of the present invention may include one or more formal email interactions. The text data 306 may further include unstructured data 310, which in at least one embodiment of the present invention may include informal text interaction such as chats and instant messages. The video data 312 may include peer-to-peer data 314 which may include video data of a customer speaking to a contact center employee or agent on a voice call where both can see each other and guiding data 316 which may include an automated help video or do-it-yourself kind of video and where there is no human interaction.

The analysis engine 318 may include one or more computer programs stored in the user computer memory 102 and/or the server computer memory 122 which are implemented by the user computer processor 106 and/or the server computer processor 126 and which cause mapping of voice analysis data 320, text analysis data 322, and video analysis data 324 to an outcome of the interaction repository 326. The “mapping” of data 320, 322, and 324 to an outcome, may include or consist of analysis of data 320, 322, and 324 and determining an outcome from the data 320, 322, and 324. Examples of ways of determining outcomes from data have been explained previously, where patterns were compared to outcomes.

The scoring engine 328 may include one or more computer programs stored in the user computer memory 102 and/or the server computer memory 122 which are implemented by the user computer processor 106 and/or the server computer processor 126 and which cause mapping scores to be given to one or more contact center employees and/or call agents based on the efficiency calculated by mapping behavior patterns to outcomes such as scores 330, 332, 334, 336, and 338 and to store these scores in the computer memory 102 and/or the server computer memory 122. In at least one embodiment, a lower score means lower efficiency and a higher score means a higher efficiency. An agent getting a score of “5” indicates that he displayed behavioral patterns in his interactions that are most likely to produce a desired result. An agent getting a score of “1” indicates that he displayed behavioral patterns that are least likely to produce a desired outcome.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
storing a first set of data related to an interaction between a customer and a contact center employee in a computer memory;
storing a second set of data regarding an outcome of the interaction in the computer memory;
using a computer processor to analyze the first set of data related to the interaction; and
using a computer processor to link the second set of data regarding the outcome to the first set of data in the computer memory.

2. The method of claim 1 further comprising
using a computer processor to determine a score for the contact center employee based on the outcome of the interaction.

3. The method of claim 2 further comprising
displaying the score for the contact center employee on a computer display.

4. An apparatus comprising
a computer processor;
and a computer memory;
wherein the computer processor is programmed by computer software stored in the computer memory to:
(a) store a first set of data related to an interaction between a customer and a contact center employee in the computer memory;
(b) store a second set of data regarding an outcome of the interaction in the computer memory;
(c) analyze the first set of data related to the interaction; and
(d) to link the second set of data regarding the outcome to the first set of data in the computer memory.

5. The apparatus of claim 4 wherein
the computer processor is further programmed by computer software stored in the computer memory to determine a score for the contact center employee based on the outcome of the interaction.

6. The apparatus of claim 5 further comprising
a computer display; and
wherein the computer processor is further programmed by computer software stored in the computer memory to display the score for the contact center employee on a computer display.
